(19) United States
(12) Patent Application Publication
(10) Pub. No.: US 2016/0338314 A1
(43) Pub. Date: Nov. 24, 2016

(54) MAT FOR PET TOILET

(71) Applicant: Yoichi YASUKAWA, Tokyo (JP)

(72) Inventor: Yoichi YASUKAWA, Tokyo (JP)

(21) Appl. No.: 15/158,636

(22) Filed: May 19, 2016

(30) Foreign Application Priority Data
May 19, 2015 (JP) 2015-102206

(51) Int. Cl. A01K 1/015; B32B 3/08; B32B 3/06; B32B 7/12

(52) U.S. Cl. CPC A01K 1/0157; B32B 7/12; B32B 3/085; B32B 3/06; B32B 2471/04; B32B 2307/744

(57) ABSTRACT

A mat for pet toilet has a base material, belt-like protrusions that have flat planes having no adhesiveness on top portions on the base material, and are arranged side by side therebetween by providing concave grooves at an interval at which no pet trips and falls in places between the grooves, and adhesive layers provided in bottom portions of the concave grooves. Granular matters for pet toilet to be attached onto legs of a pet getting out of the pet toilet are dropped and separated from the pet while the pet walks on flat portions of the belt-like protrusions on the mat for pet toilet, by arranging the mat for pet toilet around the pet toilet, fall in the adhesive layers provided between the belt-like protrusions, and are adhesively captured, and thus are not scattered on the floor around the pet toilet.

### RELATED APPLICATIONS

This invention claims the benefit of Japanese Patent Application No. 2015-102206 which is hereby incorporated by reference.

### TECHNICAL FIELD

The present invention relates to a mat for pet toilet to be arranged around the pet toilet, or under and around the pet toilet used upon urination or defecation by a pet (hereinafter, referred to as “pet”) such as a cat, a rabbit, and a guinea pig to be kept indoors, and used in order to prevent granular matters for the pet toilet, such as cat sand, from being attached onto legs or a body of the pet, after urination or defecation by the pet, brought outside the pet toilet, and widely scattered around the pet toilet to foul a circumference, and a method of producing the same.

### TECHNICAL BACKGROUND

Upon urination or defecation by a pet to be kept indoors, for example, stone and sand, bentonite or other granular matters for pet toilet, such as cat sand (hereinafter, referred to as “granular matters for pet toilet”) are put into a vessel for toilet, such as a pet toilet box made of plastics, to prepare the pet toilet, and the pet toilet into which the granular matters for pet toilet are put is arranged directly on the floor, or on paper such as newspaper or a mat laid on the floor, and used.

Thus, the pet urinates or defecates in the pet toilet arranged indoors by putting the granular matters (cat sand) for pet toilet thereinto. However, the pet has a habit of putting the granular matters for pet toilet on excrement such as feces (hereinafter, referred to as “excrement”) with hind legs after urination or defecation. Therefore, the granular matters for pet toilet are to be scattered outside the vessel such as the pet toilet box (hereinafter, referred to as “pet toilet box”). The granular matters for pet toilet as thus scattered from the pet toilet box to the circumference get dirty with the excrement of the pet, and therefore the floor around the pet toilet is to be made dirty, which is unhygienic.

Scattering of the granular matters for pet toilet into an outside of the pet toilet box as caused by such motion of the pet of putting the granular matters for pet toilet onto the excrement with the hind legs can be more or less prevented by covering the toilet box with a hood. However, even in the pet toilet box thus covered with the hood, the granular matters for pet toilet inside the pet toilet are attached onto the legs or the body of the pet, or interposed between paw pads or between the paw pads and claws. Therefore, when the pet urinates or defecates and then gets out of the pet toilet box and walks therearound, the granular matters for pet toilet inside the pet toilet are attached onto the pet, and brought out of the pet toilet box to be scattered on the floor, and scattered in a wide range indoors, which is unhygienic, and damages an indoor environment to be problematic.

Therefore, in order to drop the granular matters for pet toilet as attached onto the legs and the like of the pet, a proposal has been made on a mat on a surface of which belt-like protrusions or uneven planes are formed (PATENT DOCUMENTs 1 and 2). Moreover, in order to drop the granular matters for pet toilet as attached onto the legs, a proposal has been made on a mat for pet toilet in which a surface is formed into uneven planes having adhesiveness (PATENT DOCUMENTs 3 and 4).

However, in the mat for pet toilet as provided with the belt-like protrusions, the granular matters for pet toilet are easy to move, for example, roll, and therefore a size of the mat for pet toilet to be laid around the pet toilet is required to be significantly increased to have a large area indoors, and such a mat is obstructive. Furthermore, even if a large-area mat for pet toilet is provided as described above, the granular matters for pet toilet are not secured on the mat for pet toilet, and therefore scattering thereof is unavoidable, which is problematic.

Moreover, in the mat for pet toilet provided with independent protrusions such as columnar protrusions, the pet such as the cat dislikes relatively thin independent protrusions, as found in a cat repellent or the like, and therefore such a mat is unfavorable, and movement of the granular matters for toilet which fall in places between the protrusions cannot be stopped, and therefore scattering caused by movement of the granular matters for pet toilet is unavoidable.

Further, in the mat for pet toilet provided with the uneven surfaces having adhesiveness in order to avoid scattering and loss of the granular matters for pet toilet, the pet dislikes being tripped up by adhesiveness upon walking, as found in the cat repellent or the like, and therefore such a mate is unfavorable.

Thus, in order to prevent the granular matters for pet toilet from being scattered from the pet toilet, many proposals have been made. However, an issue of preventing the granular matters for pet toilet from being scattered from the pet toilet has not been solved yet.

### RELATED PRIOR ARTS

### Patent Document

PATENT DOCUMENT 1: Japanese Utility Model Registration No. 3040615(U)
PATENT DOCUMENT 2: Japanese Laid-Open Patent Publication No. 2000-209976(A)
PATENT DOCUMENT 3: Japanese Utility Model Registration No. 3170504(U)
PATENT DOCUMENT 4: Japanese Laid-Open Patent Publication No. H10-315365(A)

### SUMMARY OF THE INVENTION

The present invention dissolves problems in preventing granular matters for pet toilet from being scattered in the conventional mats for pet toilets as described above.

A mat for pet toilet of the present invention is arranged around a toilet box or under and around the toilet box and used, and an object of the present invention is to provide the mat for pet toilet for prevent granular matters for pet toilet from being scattered even onto the floor around the pet toilet by securing the granular matters for pet toilet on the mat for pet toilet by detaching, from a pet, the granular matters for pet toilet as attached onto the pet by the pet getting out of the pet toilet, after urination or defecation, and walking on the mat for pet toilet arranged around the pet toilet, and capturing the detached granular matters for pet toilet in a predetermined place.

### Means to Solve the Problems

In the present invention, top portions of belt-like protrusions are formed into a flat shape on which a pet is easy to walk, and adhesive layers are provided inside grooves formed with belt-like protrusions adjacent to each other. Therefore, granular matters for pet toilet as attached onto legs and the like in the toilet by the pet getting out of the pet toilet and walking on the belt-like protrusions on a mat for pet toilet are dropped from the legs and separated, and the granular matters for pet toilet as separated from the legs of this pet fall in the grooves between the belt-like protrusions from above the belt-like protrusions. Therefore, the fallen granular matters for pet toilet are secured by allowing the granular matters to adhere onto the adhesive layers inside the grooves, and capturing the granular matters so as not to easily move, and spreading and scattering of the granular matters for pet toilet can be easily prevented.

In the present invention, as described above, the grooves are formed with the belt-like protrusions adjacent to each other, and simultaneously the adhesive layers are provided inside the grooves in the mat for pet toilet, and the granular matters for pet toilet as separated from the pet drop in the adhesive layers inside the grooves between the belt-like protrusions and captured therein. However, the present inventors have further found that the granular matters for pet toilet as captured in the adhesive layers on the mat for pet toilet can be easily removed from the adhesive layers by sweeping the adhesive layers on the mat for pet toilet with a brush or the like, tapping the mat for pet toilet, or washing the mat with water, and that the granular matters for pet toilet can be removed from the adhesive layers by sweeping a top of the adhesive layers with the brush or the like, tapping the mat for pet toilet, or washing the mat with water, even for the adhesive layers attached with the granular matters for pet toilet, and adhesive planes of the adhesive layers on the mat for pet toilet can be easily regenerated, and the mat can be used again as the mat for pet toilet, and thus the present inventions have completed the present invention.

That is, the present invention relates to a mat for pet toilet, including a base material, a plurality of belt-like protrusions provided on the base material, in which flat planes having no adhesiveness are formed on top portions over entire length thereof, belt-like grooves formed with the belt-like protrusions adjacent to each other, and adhesive layers formed on bottom planes of the grooves.

Moreover, the present invention relates to a mat for pet toilet, including a base material, adhesive layers provided on the base material, a plurality of belt-like protrusions in which flat planes having no adhesiveness are formed on top portions over entire length thereof, and being adhesively provided onto the adhesive layers, belt-like grooves formed with the adhesive layers and the belt-like protrusions adjacent to each other.

Further, the present invention relates to a mat for pet toilet, including a base material, a plurality of adhesive layers arranged side by side by providing gaps between the layers on a surface of the base material, a plurality of belt-like protrusions in which flat planes having no adhesiveness are formed on top portions over entire length thereof, and having bottom plane portions adhered, across the gaps between the adhesive layers on the base material surface, onto the adhesive layers on both sides interposing gaps, and belt-like grooves formed with the adhesive layers and the belt-like protrusions adjacent to each other.

Further, the present invention relates to a mat for pet toilet, including a base material, a plurality of adhesive layers arranged side by side on a surface of the base material by providing gaps between the layers, belt-like protrusions in which flat planes having no adhesiveness are formed on top portions over entire length thereof, and having bottom plane portions adhered, across the gaps between the adhesive layers on the surface of the base material, onto the adhesive layers on both sides interposing the gaps, belt-like protrusions in which bottom plane portions are directly adhered onto the base material through the adhesive layers on the bottom plane portions, and belt-like grooves formed with the adhesive layers and the belt-like protrusions adjacent to each other, in which the belt-like protrusions are adhered or bonded onto a base material plane through an adhesive agent or a bonding agent in the gaps between the adhesive layers.

The present invention relates to a method of producing a mat for pet toilet, in which adhesive layers are provided on a base material plane to adhere, onto the adhesive layers on the base material plane, a plurality of belt-like protrusions in which flat planes having no adhesiveness are formed on top portions, and being extended in a belt-like form and formed, and belt-like grooves are formed with the belt-like protrusions adjacent to each other, and adhered, respectively.

Moreover, the present invention relates to a method of producing a mat for pet toilet, in which belt-like protrusions in which flat planes having no adhesiveness are formed on top portions, and adhesive layers are provided on bottom planes and formed in a belt-like form on a base material surface onto which adhesiveness-providing substances are adhered by providing gaps, and a plurality of adhesive layers extending in a belt-like form are arranged side by side by providing the gaps are adhered in the bottom planes, across the gaps between the adhesive layers on the base material surface, onto the adhesive layers on both sides of the gaps, respectively, and simultaneously the belt-like protrusions are directly adhered onto the base material surface through the adhesive layers provided on the bottom planes or the adhesive layers provided inside the gaps between the adhesive layers on the base material, and a plurality of belt-like protrusions are provided on the base material surface by forming belt-like grooves between the layers, respectively.

Then, the mat can have side walls by closing opening portions on both sides of the belt-like grooves formed with the belt-like protrusions adjacent to each other in the mat for pet toilet of the present invention. Furthermore, with regard to the method of producing the mat for pet toilet of the present invention, release portions on both ends of the grooves can be closed by providing the side walls for the release portions on both ends of the vertically arranged and formed grooves, respectively.

In the present invention, a region in which the pet toilet is placed is formed in the mat for pet toilet, and the belt-like protrusions and the adhesive layers can be formed in a region outside the region in which the pet toilet is placed.

Thus, the pet toilet is placed in the region in which the pet toilet is placed, and used in the mat for pet toilet in which the region in which the pet toilet is placed is formed. If the pet toilet is placed in the region in which the pet toilet is placed, and used, the mat for pet toilet becomes hard to move by weight of the pet toilet, and a position of the mat for pet toilet is stabilized, and therefore such a case is preferable. If the region in which the pet toilet is placed is formed in an end portion of the mat for pet toilet, the pet toilet can be easily placed in the region in which the pet toilet is placed by inserting, under the pet toilet, the region in which the pet toilet is placed, for example.

In the present invention, the flat plane having no adhesiveness on the top portion of the protrusion is formed on the belt-like protrusion, namely, the flat plane at least having no properties of adhering the pet, the base material, and the granular matters for pet toilet, and at least having the flat shape on which the pet is easy to walk, and the flat shape that is not disliked by the pet in the pet walking is formed thereon. Further, the belt-like protrusions are arranged side by side by providing, between the gaps on the base material, the gap having a size at which no legs fall down upon walking of the pet such as the cat in such a manner that the groove is formed with the belt-like protrusions adjacent to each other and the base material. Moreover, in the present invention, with regard to the groove formed with the belt-like protrusions adjacent to each other, both walls of the groove are formed with the belt-like protrusions, and the bottom plane of the groove is formed with the adhesive layer. Further, in the present invention, the belt-like protrusions adjacent to each other and the groove formed with the belt-like protrusions can be formed integrally with the base material. In this case, a belt-like groove portion is formed between a belt-like convex portion and a belt-like convex portion on the base material, and the adhesive layer is formed in the bottom portion of the groove portion.

However, in the present invention, the belt-like protrusions can be arranged side by side on the base material by providing the gap with each other, independently of the base material. In this case, the plurality of belt-like protrusions are arranged side by side on the base material by providing the gap at a degree in which no legs of the pet fall down. The groove is formed with two belt-like protrusions adjacent to each other. In this case, both sides of the groove are formed with the belt-like protrusions, the bottom plane of the groove is formed with the base material, and the adhesive layer is provided on the base material on the bottom plane of the groove. In the present invention the adhesive layer is an adhesive layer having properties of being adhered onto at least the granular matters for pet toilet and the base material, and can be formed by applying the adhesive agent onto the bottom plane of the groove and transferring the tape thereon, attaching a transfer type adhesive tape onto the bottom plane of the groove, or attaching an adhesive layer on one plane of a double coated tape onto the bottom plane of the groove. Moreover, the bottom plane of the groove can be formed with the adhesive layer provided on the base material. In this case, the bottom plane of the groove is formed with the adhesive layer provided on the base material, and the belt-like protrusions can be arranged side by side in the adhesive layer by providing the gap at a degree at which no legs of the pet such as the cat fall down.

In any of the cases of the mats for pet toilet, the granular matters for pet toilet drop from the legs of the pet in a process in which the pet walks on the flat plane of the belt-like protrusion, and the dropped granular matters for pet toilet fall in the groove, are adhered onto the adhesive layer provided on the bottom plane of the groove and captured thereon. In the present invention the adhesive layer is an adhesive layer at least having properties of being adhered onto the granular matters for pet toilet and the base material, and can be formed by applying the adhesiveness-providing substance such as the adhesive agent, or attaching the adhesive tape thereonto. In the present invention, with regard to the groove formed with the belt-like protrusions adjacent to each other, both end portions thereof (hereinafter, referred to as “both end portions”) in a longitudinal direction are in a release state, but can be blocked by providing the side walls on the both end portions, and closing the release portions on both ends of the groove. Thus, storage capacity of the granular matters for pet toilet in the groove can be enhanced by blocking the release portions on both ends of the groove to prevent the granular matters for pet toilet from being scattered and lost from the both end portions of the groove over a long period of time.

In the present invention, the belt-like protrusion can be formed with wood, plastics, rubber or metal, and may be a dense body or a hollow body. Moreover, the belt-like protrusion can be formed in the adhesive layer formed on the base material surface by providing the gap between the layers. Thus, if the belt-like protrusion is formed of an elastic material, the flat plane formed on the top portion of the belt-like protrusion serves as an elastic plane, and when the pet walks on the flat plane on the top portion of the belt-like protrusion, the granular matters for pet toilet as attached onto the legs become easy to drop from the legs of the pet by a change in elasticity of the bottom portion by the legs of the pet as caused by elastic action of the belt-like protrusion, and therefore such a case is preferable.

Moreover, in the present invention, the belt-like protrusion having the flat plane on the top portion can be formed in the adhesive layer preliminarily provided at an interval on the base material surface by compression bonding of each belt-like protrusion. In order to provide the adhesive layer in the predetermined place on the base material surface, if the adhesive layer for the belt-like protrusion is formed in advance on the base material by attaching the double coated tape onto the predetermined place on the base material surface or applying the adhesive agent thereonto to mark a place to which the belt-like protrusion is adhered, for example, work of adhering the belt-like protrusion onto the predetermined place on the base material is facilitated, and can be easily performed, and therefore such a case is preferable. Moreover, when the adhesive layers are arranged side by side on the base material surface by providing the belt-like gap, if the adhesive layer for the belt-like protrusion for allowing the belt-like protrusion to directly adhere onto the base material is provided inside the gap, or if the adhesive layer for the belt-like protrusion for allowing the belt-like protrusion to directly adhere onto the base material is provided in a place corresponding to the inside of the gap on the bottom plane of the belt-like protrusion, the bottom plane portion of the belt-like protrusion is adhered, across the gap between the adhesive layers on the base material, onto the adhesive layers on both sides interposing the gap, and simultaneously the base material surface, and the bottom plane portion of the belt-like protrusion are to be adhered through the adhesive agent for the belt-like protrusion inside the belt-shaped gap in the adhesive layer on the base material. In this case, if adhesion between the bottom plane portion of the belt-like protrusion and the base material surface is enhanced to adjust the adhesive layer for adhesively capturing the granular matters on the base material into a form of interposing the adhesive layer between the base material, and the belt-like protrusion the adhesive layer for adhesively capturing the granular matters for pet toilet on the base material is formed into a style in which the adhesive layer is held onto the base material from above by the belt-like protrusion, and the adhesion of the adhesive layer for adhesively capturing the granular matters for pet toilet onto the base material onto the base material can be stabilized.

In the present invention, the belt-like protrusion can be formed by directing a direction of the flat plane on the top portion extending in the belt-like form toward an appropriate direction relative to a direction of an edge of an inlet and outlet of the pet in the pet toilet. However, if the belt-like protrusion is formed in such a manner that the direction of the flat plane of the belt-like protrusion extending in the belt-like form is in parallel to the direction of the edge of the inlet and outlet of the pet in the pet toilet, a belt-like row of the belt-like protrusions becomes perpendicular to a direction in which the pet gets out of the inlet and outlet in the pet toilet and walks, and the pet strides over the groove between the belt-like protrusions in a process in which the pet walks following on the flat plane of the belt-like protrusion, and therefore the granular matters for pet toilet as attached onto the legs of the pet are detached and separated from the legs, and drops onto the adhesive layer of the groove bottom portion, and are captured, and therefore such a case is preferable.

In the present invention, the belt-like protrusion to be formed on the mat for pet toilet has the flat portion on the top portion, and a cross-sectional shape (hereinafter, referred to as “cross-sectional shape”) cut in a direction perpendicular to the direction extending in the belt-like form can be formed, for example, into a rectangle, a trapezoid, a polygon, a truncated circle or a truncated elliptic shape having the flat plane in an upper end portion, and can be formed into the dense body or the hollow body. When the belt-like protrusion has the rectangle, the plurality of belt-like protrusions each have a width of the flat portion on the top portion from 12 to 16 mm and a height thereof from 8 to 17 mm are arranged side by side at an interval from 7 to 11 mm to each other. If the protrusions are formed in such a manner, even if the pet should take a false step upon walking on the flat portion on the belt-like protrusion, a case of falling in the groove is eliminated, and therefore such a belt-like protrusion is suitable for walking of the pet, and the granular matters for pet toilet as attached onto the legs of the pet are dropped and separated from the legs of the pet, fall in the adhesive layer between the belt-like protrusions, and are surely captured, and therefore such a case is preferable. Even though the cross-sectional shape of the belt-like protrusion has the trapezoid, the interval between the flat portions on the top portions of the belt-like protrusions, namely, a size in opening between the grooves is required to be adjusted to the size at which the pet does not fall down in the groove even if the pet takes the false step upon walking of the pet. The size is preferably adjusted to 7 to 11 mm, and even in a base portion of the belt-like protrusion, preferably adjusted to about 5 mm. Moreover, when the cross-sectional shape of the belt-like protrusion has the trapezoid, the region of the adhesive layer can be extended to an inclined plane thereof.

The adhesive layer used in the mat for pet toilet of the present invention can be formed by applying the adhesiveness-providing substance such as the adhesive agent onto the base material surface according to a method such as direct coating or transfer coating. Moreover, the adhesive layer formed on the base material plane can also be formed by attaching the double coated tape onto the base material plane. When the double coated tape is thus attached thereonto, adhesive force of the adhesive agent on a side of the double coated tape being adhered onto the base material surface can be made larger than adhesive force of the adhesive layer on a side of adhesively capturing the granular matters for pet toilet, and the adhesive layer can be adhered onto the base material by the adhesive force by using the double coated tape.

In the present invention, the granular matters for pet toilet as adhesively captured in the adhesive layer are preferably adhesively captured with the adhesive force at a degree at which the granular matters can be easily separated and removed from the mat for pet toilet by sweeping the mat with the brush or the like, or tapping, with a rod, a duster or the like, the mat for pet toilet on which the granular matters for pet toilet are adhesively captured, or flowing the granular matters with water.

In the present invention, as the adhesiveness-providing substance having such adhesive force, for example, an ordinary bonding agent such as a rubber-based bonding agent, an acryl-based bonding agent, and a silicone-based bonding agent can be used, and a commercially available adhesive tape or double coated tape can be used.

In the present invention, as a rear plane of the base material, for example, the mat on which a friction plane for preventing slip is formed is preferable so as to avoid easy slip upon laying the mat on the floor or the like.

In the present invention, the base material (support) is preferably formed into an easily foldable material. Specific examples of such a material include paper such as kraft paper and coated paper used as cardboard, rubber, a film such as a polyvinyl chloride film, a polyethylene film, and a polypropylene film, a foamed polyolefin sheet such as polyethylene foam and a foamed polyurethane sheet.

In the present invention, if the base material is manufactured using the easily foldable material, the mat for pet toilet can be folded upon storing the mat, and therefore the mat takes up little space, and such a case is preferable. Moreover, even a material having elasticity can be used, for example, by adjusting thickness to be foldable, or folding the material into a storage bag or the like and adjusting the material to be stably storable. Thus, if the material can be folded into the storage bag, and stably stored, even the material having elasticity can be used.

Moreover, in the present invention, a center part of the base material can be formed, for example, into a folding-line part without forming the belt-like protrusion and the adhesive layer in order to form the mat for pet toilet to be foldable. Thus, if the folding-line part is formed on the mat for pet toilet, with regard to bending of the part, neither the belt-like protrusion nor the adhesive layer is formed, and therefore bending thereof is not required, and only work of bending the cardboard is required, for example, and the mat for pet toilet can be simply and easily folded.

Thus, the mat for pet toilet can be simply and easily folded by bending the folding-line part in the mat for pet toilet of the present invention, and therefore the mat takes up no spaced, and easily displayed in the shop or packed, and therefore such a case is preferable.

Moreover, in the present invention, a commercially available single coated adhesive tape or adhesive sheet can be used as the base material having the adhesive layer. Moreover, an appropriate plastics film, plastic sheet or foamed plastic sheet is used as the base material, and onto the surface thereof, the bonding agent is applied, or subjected to transfer coating, or the double coated adhesive tape or double coated adhesive sheet is attached, and the resultant material can be taken as the base material having the adhesive layer.

In the present invention, if the adhesive layer is provided on the base material by forming a belt-like or punctiform gap thereon, an amount of use of the adhesiveness-providing substance can be saved by a portion in which the gap is provided for the adhesive layer. In this case, the belt-like protrusions are adhered, across the gaps between the adhesive layers, onto the adhesive layers on both sides facing to each other by interposing the gaps between the adhesive layers or onto the end portions of the adhesive layers existing around the gaps. A region of the end portion of the adhesive layer onto which the belt-like protrusion is adhered or the region serving as so-called overlap width has a width of 1.5 to 2.5 mm from the edge of the gap between the adhesive layers, for example.

In the present invention, with regard to a height for the plurality of belt-like protrusions, the belt-like protrusion close to an edge portion of the base material is adjusted to be higher than the belt-like protrusion far from the edge portion. Thus, accordingly as the protrusions come closer to the edge portion of the base material, the granular matters for pet toilet can be made harder to fall out. Moreover, the pet can be easily guided to the vicinity of the center portion of the base material.

Moreover, a wall portion higher than the belt-like protrusion is provided along the edge portion of the base material in the present invention. Thus, the granular matters for pet toilet can be effectively prevented from falling out of the base material.

In the present invention, when the adhesive layers are formed on the base material surface by providing the gaps inside the adhesive layers or the adhesive layers are formed by providing the gaps between the layers, as the adhesive layers for the belt-like protrusions for adhering the belt-like protrusions onto the base material, the adhesive layers for the belt-like protrusions can be provided inside the gaps provided in the adhesive layers, or the adhesive layers each having the size at which the adhesive layer can be put inside the gap can be provided on the bottom planes of the belt-like protrusions. Thus, the bottom plane of the belt-like protrusion can be directly adhered onto the base material surface through the adhesive layer for the belt-like protrusion, and simultaneously adhered onto the adhesive layer on the base material surface. Thus, if the belt-like protrusions are adhered onto the base material having the adhesive layers through two kinds of adhesive layers, namely the adhesive layer for the belt-like protrusion for directly adhering the belt-like protrusion onto the base material surface, and the adhesive layer for adhering the belt-like protrusion onto the adhesive layer on the base material surface, the adhesive layer for capturing the granular matters for pet toilet, such as the cat sand, and the adhesive layer for the belt-like protrusion for directly adhering the belt-like protrusion onto the base material can be formed with the adhesive agents providing the adhesive layers with different adhesive force.

In the present invention, two kinds of adhesive layers can be used for adhesion of the belt-like protrusions as described above, and the adhesive force at which the belt-like protrusion is attached onto the base material can be significantly increased in comparison with the adhesive force at which the granular matters for pet toilet are captured, and the adhesive force at which the granular matters for pet toilet are captured is significantly decreased in comparison with the adhesive force at which the belt-like protrusion is attached onto the base material. Thus, the captured granular matters for pet toilet can be easily separated, for example, by sweeping the mat with the brush, and cleaning of the mat for pet toilet becomes simple and easy, and therefore such a case is preferable.

In this case, the adhesive layer can be formed on the bottom plane of the belt-like protrusion, for example, by coating the adhesiveness-providing substance of the adhesive agent onto the bottom plane of the belt-like protrusion in a linear form or punctiform state in a major axis direction connecting center portions of both end portions in a minor axis direction. Thus, the adhesive layer is easily formed onto the surface of the belt-like protrusion by applying the adhesive agent or the like to facilitate adhesion of the belt-like protrusion onto the base material surface through the adhesive layer on the base material surface, and simultaneously direct adhesion of the belt-like protrusion, through the gap between the adhesive layers on the base material plane, onto the base material surface through the adhesive layer on the bottom plane of the belt-like protrusion.

Thus, in the present invention, the end portion on the bottom plane of the belt-like protrusion is to be adhered onto the adhesive layer for adhesively capturing the granular matters for pet toilet, the adhesive layer having the gap provided on the base material surface, and simultaneously directly adhered onto the base material through the adhesive layer for the belt-like protrusion as provided in the adhesive layer provided in the center part on the bottom plane of the belt-like protrusion, or provided inside the gap between the adhesive layers for adhesively capturing the granular matters for pet toilet on the base material surface. Thus, the adhesive layer on the base material surface is formed into the style in which the adhesive layer on the base material surface is held toward the base material by the belt-like protrusion, and the adhesive layer can be formed to be hard to peel relative to the base material.

In the mat for pet toilet of the present invention, the pet such as the cat getting out of the pet toilet is to walk on the flat portion on the top portion of the belt-like protrusion on the mat for pet toilet, and in the process of walking of the pet, the granular matters for pet toilet as attached onto the legs are dropped from the legs of the pet and separated therefrom. The separated granular matters for pet toilet fall in the adhesive layer formed on the bottom plane of the groove between the belt-like protrusions, and are surely captured by the adhesive layer inside the mat for pet toilet, and therefore scattering around the circumference can be avoided.

In the present invention, the opening portions on both ends of the groove formed between the belt-like protrusions and having the adhesive layer on the bottom plane can be blocked by providing the side walls, lines or the like on both end portions thereof. Thus, the granular matters for pet toilet as captured inside the groove can be prevented from being escaped from the both end portions of the groove.

Accordingly, in the mat for pet toilet of the present invention, the granular matters for toilet are attached onto the pet and brought out of the pet toilet. While the pet walks inside the mat for pet toilet, the granular matters are dropped from the pet, fall in the mat for pet toilet, and adhesively captured by the adhesive layer. Therefore, the granular matters are not scattered on the floor around the mat for pet toilet, an environment around the pet toilet can be improved, and an environment in a room can be kept hygienic and satisfactory.

### Advantageous Effects of the Invention

A mat for pet toilet of the present invention has simple structure of including a base material having an adhesive layer provided on a surface, and a plurality of belt-like protrusions having flat planes having no adhesiveness on top portions over entire length thereof, in the adhesive layers on the base material, and arranged side by side by providing gaps between the layers. The mat for pet toilet is arranged around the pet toilet, and can detach granular matters for pet toilet as attached onto the pet getting out of the pet toilet after urination or defecation and separate before the pet walks on a flat portion of a belt-like protrusion and separate the granular matters. Then, the separated granular matters for pet toilet fall into a groove between the belt-like protrusions, and are adhesively captured by the adhesive layer. The captured granular matters for pet toilet are held in a state in which the granular matters are adhesively captured by the adhesive layer. The adhesively captured granular matters for pet toilet are limited in movement, and therefore are not scattered on the floor around the pet toilet, an environment in a room can be kept hygienic and satisfactory, and an environment around the pet toilet can be improved.

Moreover, in the present invention, the mat for pet toilet is produced by providing the adhesive layers on the base material plane, and attaching, onto the adhesive layers, a plurality of belt-like protrusions in which the flat planes having no adhesiveness are formed on the top portions through the adhesive layers by providing the gaps between the layers. Therefore, the belt-like protrusions in which the flat planes having no adhesiveness are formed on the top portions can be easily arranged side by side in the adhesive layers on the base material surface through the adhesive layers by providing the gaps, and therefore a production process can also be simplified, and mass production can be furthermore achieved with an inexpensive material, and therefore the mat for pet toilet can be provided at a low cost, usability is high, and the pet can be bred under a good environment.

Moreover, in the mat for pet toilet of the present invention, the granular matters for pet toilet are captured after use by adhesive portions inside grooves between belt-like protrusions. The captured granular matters for pet toilet during use are accumulated inside the mat for pet toilet, but the granular matters for pet toilet as accumulated between the belt-like protrusions can be removed at least partially by sweeping places between the belt-like protrusions on the mat for pet toilet with the brush or tapping the mat for pet toilet, or washing the mat with water, and therefore the mat for pet toilet can be repeatedly used.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 is a schematic side cross-sectional view for describing a mat for pet toilet in one Example of the present embodiment.

FIG. 2 is a schematic plan view for describing the mat for pet toilet in one Example shown in FIG. 1 according to the present invention.

FIG. 3 is a schematic plan view shown by cutting away both end portions for describing a mat for pet toilet in another Example of the present invention, being different from Example shown in FIG. 2.

FIG. 4 is a schematic partially enlarged side cross-sectional view for describing a mat for pet toilet in another Example of the present invention, being different from Example shown in FIG. 1.

FIG. 5 is a schematic partial side cross-sectional view for describing a mat for pet toilet in another Example of the present invention, being different from Examples shown in FIG. 1 and FIG. 4.

FIG. 6 is a schematic partial side cross-sectional view for describing a mat for pet toilet in another Example of the present invention, being different from Example shown in FIG. 1.

FIG. 7 is a schematic partial side cross-sectional view for describing the mat for pet toilet in one Example shown in FIG. 6 according to the present invention.

FIG. 8 is a schematic partial side cross-sectional view for describing a mat for pet toilet in another Example of the present invention, being different from Example shown in FIG. 7.

FIG. 9 is a view for describing a mat for pet toilet as related to other Examples.

FIG. 10 is a view for describing a mat for pet toilet as related to other Examples.

### DESCRIPTION OF THE EMBODIMENTS

Hereinafter, examples of embodiments of the present invention are described with reference to attached drawings, but the present invention is not limited at all by the following descriptions and illustrations.

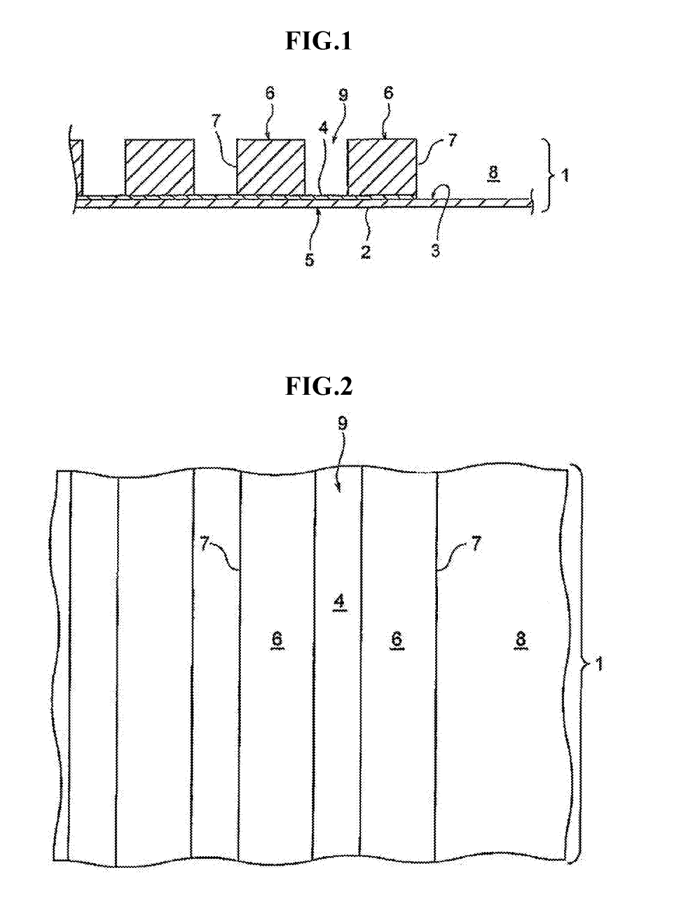

Examples shown in FIG. 1 and FIG. 2 each are a case in which one example of the embodiments of the present invention is described. In Examples shown in FIG. 1 and FIG. 2, on a base material 2 of a mat 1 for pet toilet, adhesive layers 4 are formed wholly on a surface 3 thereof, and a rear plane 5 thereof is formed into a rough plane in such a manner that the mat is not easily moved and is hard to slip. In the present example, the adhesive layers 4 are formed by applying an adhesiveness-providing substance, for example, an adhesive agent according to various application methods.

Examples shown in FIG. 1 and FIG. 2 each are a case in which one example of the embodiments of the present invention is described. In Examples shown in FIG. 1 and FIG. 2, on the base material 2 on the mat 1 for pet toilet, the adhesive layers 4 are formed wholly on the surface 3 thereof, and the rear plane 5 thereof is formed into the rough plane in such a manner that the mat is not easily moved and is hard to slip. In the present example, the adhesive layers 4 are formed by applying the adhesive agent according to various application methods. In the present example, a plurality of belt-like protrusions 7 in which top planes 6 are formed on flat planes having no adhesiveness (a sign is provided for only a right end portion, and the sign is omitted for others) are adhesively fixed side by side on the adhesive layers 4 of the base material 2 at an interval at which legs of a pet (hereinafter, referred to as “pet”) such as a cat are not got thereinto.

In the present example, the adhesive layer 4 is formed in a position lower, by a height of the belt-like protrusion 7, than a position of the top plane 6 of the belt-like protrusion 7, namely, by being interposed between base portions of belt-like protrusions 7 adjacent to each other to form grooves 9 between the adjacent two belt-like protrusions 7, and the adhesive layers 4 in bottom portions. Thus, in the present example, the bottom portions are formed with the adhesive layers between the belt-like protrusions 7, and the belt-like protrusions 7 are vertically arranged on both sides by interposing the adhesive layers of the bottom portions and the grooves 9 are formed. Therefore, in a process in which the pet walks on the belt-like protrusions 7, granular matters (not shown) for pet toilet as attached onto the legs of the pet are dropped from the legs, fall in the bottom portions on a side of the belt-like protrusions 7, are adhesively captured by the adhesive layers 4 of the bottom portions, and are accumulated inside the grooves 9.

The mat 1 for pet toilet of the present example is provided with a pet toilet arrangement portion 8 in one end portion thereof. On the pet toilet arrangement portion 8 on the mat 1 for pet toilet, neither the adhesive layer 4 nor the belt-like protrusion 7 are provided so that the mat can be used by placing a pet toilet (not shown) thereon, or being inserted under the pet toilet.

However, the mat 1 for pet toilet of the present example is not limited to a mat for pet toilet, the mat of a type of having such a pet toilet arrangement portion. For example, the mat can also be formed into a mat for pet toilet, the mat of a type only for prevention of scattering of the granular matters for pet toilet, such as cat sand, in which only the adhesive layers 4 and the belt-like protrusions 7 are formed on the base material. Such a mat for pet toilet, the mat of the type in which no pet toilet arrangement portion 8 is provided is used by being connected to the mat for pet toilet, the mat of the type in which the pet toilet arrangement portion 8 is provided, and is exclusively used as a mat 1 only for prevention of scattering of the granular matters for pet toilet, such as the cat sand, or sand.

In the mat 1 for pet toilet as shown in FIG. 1 and FIG. 2 of the present example, the pet toilet arrangement portion 8 is provided in the end portion, and in parts other than the pet toilet arrangement portion 8, the belt-like grooves 9 having the belt-like protrusions 7 and the adhesive layers 4 for prevention of scattering of the granular matters for pet toilet are formed.

The mat 1 for pet toilet of the present example is formed as described above, and therefore a pet toilet (not shown) attached with a hood is arranged in the pet toilet arrangement portion 8 in the end portion in such a manner that a direction in which an edge of an inlet and outlet of the pet in the pet toilet extends is in parallel to a belt-like longitudinal direction of the belt-like protrusion 7 and the belt-like groove 9 in the mat 1 for pet toilet.

In the present example, the pet such as the cat after urination or defecation in the pet toilet performs sand-putting motion, but the granular matters for pet toilet (hereinafter, referred to as “granular matters for pet toilet”), such as cat sand and toilet sand as scattered around a circumference by the motion are limited to a direction of the hood in the inlet and outlet of the pet in a scattering direction thereof, and therefore fall in the mat 1 for pet toilet as positioned around the pet toilet, and are adhesively captured by the adhesive layers 4 inside the grooves 9. Moreover, the granular matters for pet toilet as attached onto the legs or a body of the pet getting out of the pet toilet are dropped from the legs and the body of the pet, in the process in which the pet walks on the flat planes of the belt-like protrusions 7 on the mat 1 for pet toilet, and adhesively captured by the adhesive layers 4 in the grooves 9.

### Example 1

In a mat 1 for pet toilet as shown in FIG. 1 and FIG. 2, a base material was taken as a base material 2 having an adhesive layer 4 by cutting a commercially available sheet having a dimension of a width of 90 cm and a length of 90 cm under a trade name “COLOR LIFE NON SLIP CLOSET SHEET” (made of polyethylene) (purchased in DAISO INDUSTRIES CO., LTD.) into a width of 45 cm and a length of 90 cm to take, as a pet toilet arrangement portion 8, a plane in 20 cm from an end portion, and applying an adhesive agent onto other planes. A material for a belt-like protrusion was prepared by cutting, on the base material 2, a tape having a dimension of a height of 0.8 cm, a width of 1.5 cm and a length of 1 m under a trade name “Airtight Tape for Window” made of polyurethane (purchased in DAISO INDUSTRIES CO., LTD.) into a height of 0.8 cm, a width of 1.5 cm and a length of 45 cm. The mat 1 for pet toilet was prepared by peeling release paper on a side of a rear plane of the tape for the belt-like protrusion to expose an adhesive plane of the adhesive layer, and adhering the belt-like protrusions onto the adhesive layers 4 of the base material 2 in a crosswise direction at an interval of 1.0 cm to each other toward a longitudinal direction thereof, and forming a plurality of belt-like protrusions 7 in the adhesive layers 4 of the base material 2.

In the present example, as a raw material for the belt-like protrusion, the tape in which the adhesive layer is formed on the rear plane is used, but a material in which no adhesive layer is formed on the rear plane side can also be used as the raw material for the belt-like protrusion.

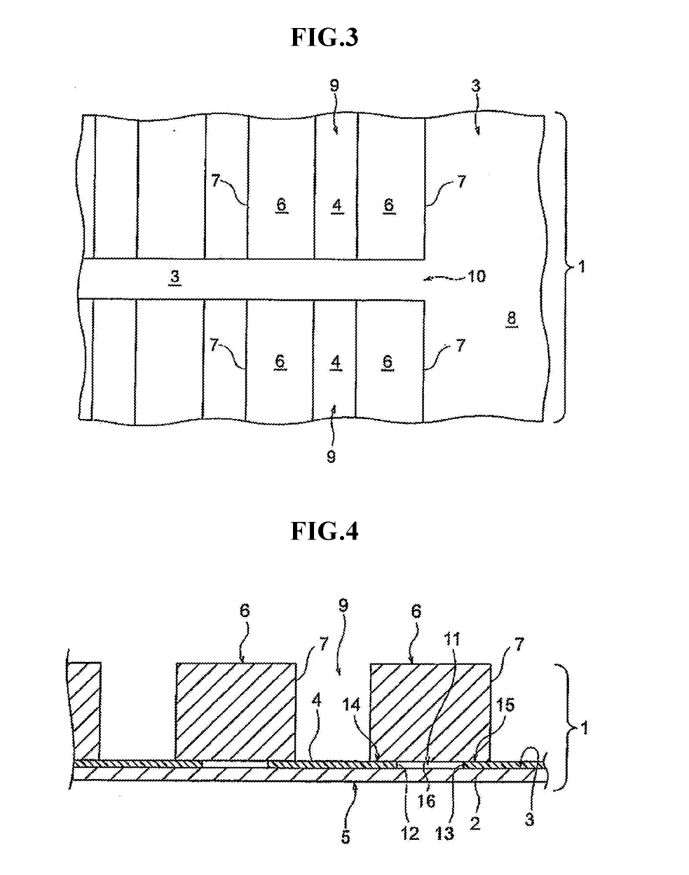

Example shown in FIG. 3 is a case that is different in comparison with Example shown in FIG. 2, in providing a folding-line portion 10 on a mat 1 for pet toilet so that the mat can be folded into two in the crosswise direction. That is, Example shown in FIG. 3 is the case in which a place without forming the belt-like protrusion 7 and the adhesive layer 4 is provided to be taken as the folding-line portion 10 so as to fold the mat 1 for pet toilet to avoid taking up space, to be easily foldable or foldable into two in the crosswise direction.

In the present example, the folding-line portion 10 is formed without providing the belt-like protrusion 7 and the adhesive portion 4, for example, in a center part of the belt-like protrusion 7 in the crosswise direction or for every predetermined length of the belt-like protrusion 7 in the crosswise direction, at a size at which no legs of the pet are put thereinto, for example, a width of 5 to 10 mm. Moreover, the folding-line portion 10 can be formed by providing a notch in the center part of the belt-like protrusion 7 or for every predetermined length of the belt-like protrusion 7. Thus, for example, the folding-line portion 10 formed at a width of 5 to 10 mm is also provided with no adhesive layer 4 in a manner similar to no belt-like protrusion 7.

In the present example, in a bending place of the mat 1 for pet toilet, the folding-line portion 10 is formed without providing the belt-like protrusion 7 and the adhesive layer 4 on the base material 2. Therefore, if the mat 1 for pet toilet is folded in the folding-line portion 10 upon folding the mat, the mat receives no action by elasticity of the belt-like protrusion 7 and adhesiveness of the adhesive layer, and storage of the mat 1 for pet toilet is facilitated, and no bulge of the belt-like protrusion 7 is caused in a bending part of the mat 1 for pet toilet, and no space is taken up in storage of the mat 1 for pet toilet.

### Example 2

A base material having an adhesive layer for a mat 1 for pet toilet was prepared in a manner similar to Example 1. That is, a base material 2 having an adhesive layer 4 was prepared by cutting a commercially available sheet having a dimension of a width of 90 cm and a length of 90 cm under a trade name “COLOR LIFE NON SLIP CLOSET SHEET” (made of polyethylene) (purchased in DAISO INDUSTRIES CO., LTD.) into a width of 45 cm and a length of 90 cm to take, as a pet toilet arrangement portion 8, a plane in 20 cm from an end portion, and applying a bonding agent onto a base material plane 2 except a folding-in portion 10 to be formed in a central portion in width of the folding-in portion 10 in being extended in a length direction at a width of 0.5 cm.

On the other hand, an airtight tape for a belt-like protrusion was prepared by cutting a tape having a dimension of a height of 0.8 cm, a width of 1.5 cm and a length of 1 m under a trade name “Airtight Tape for Window” made of polyurethane (purchased in DAISO INDUSTRIES CO., LTD.) into a height of 0.8 cm, a width of 1.5 cm and a length of 22.25 cm. With regard to the thus prepared airtight tape for the belt-like protrusion, right and left two belt-like protrusions 7 in a first row were formed by peeling release paper on a rear plane side to expose an adhesive plane of an adhesive layer, attaching the airtight tape, in a belt-like form, onto the adhesive layer 4 of the base material 2 in a crosswise direction, and further except the folding-line portion 10, attaching the airtight tape, in a belt-like form, onto the adhesive layer 4 adjacent in the crosswise direction, in arrangement in same rows with the already attached belt-like protrusions 7 in the crosswise direction. Subsequently, right and left two belt-like protrusions 7 in a second row were formed by attaching the airtight tapes, in a belt-like form in the same rows, respectively, onto the right and left two belt-like protrusions 7 in the first row in the length direction of the base material 2 by providing a gap of 1.0 cm to each other. Hereinafter, a mat 1 for pet toilet in which a folding-line was provided was formed by sequentially attaching the airtight tapes, in a belt-like form in the same rows, respectively, onto the right and left two belt-like protrusions 7 in a previous row in the length direction of the base material 2 by providing a gap of 1.0 cm to each other, and forming right and left two belt-like protrusions 7 in a plurality of rows.

Although the tape having the adhesive layer formed on the rear plane side was used as the raw material for the belt-like protrusion in the present example, a material having no adhesive layer formed on the rear plane side can also be used as the raw material for the belt-like protrusion.

Example shown in FIG. 4 is a case that is different in comparison with Example shown in FIG. 1, in forming a gap 11 in a stripe form along a belt-like protrusion 7 in a longitudinal direction, in a place of adhering the belt-like protrusion 7 on an adhesive layer 4 on a base material 2 onto which the belt-like protrusion 7 is adhered. In Example shown in FIG. 4, in the adhesive layer 4, at least one line of the gap 11 is formed, in the place in which the belt-like protrusion 7 is adhesively fixed, in a direction extending in a belt-like form, and the belt-like protrusion 7 is adhesively fixed, across the gap 11 in the adhesive layer 4, onto adhesively fixed portions (overlap width) 14 and 15 of the belt-like protrusion 7 on an upper plane of edges 12 and 13 facing each other in interposing the gap 11 in the adhesive layer 4, and is provided in the adhesive layer 4.

In the present example, the adhesive layer 4 on which the belt-like protrusion 7 is adhesively fixed can be formed, for example, by attaching a double coated tape having a predetermined width (a width having length obtained by adding, to a spread length of opening of a groove 9, a length of width of the adhesively fixed portions 14 and 15 being the overlap width on the belt-like protrusion 7) onto the base material 2, at a gap corresponding to the gap 11 in the adhesive layer 4, in a direction along a longitudinal direction of the belt-like protrusion 7 to be adhered. Moreover, the adhesive layer 4 can be formed, for example, by printing and applying an adhesiveness-providing substance on the base material 2 over entire length in a direction of extending the belt-like protrusion of the base material, at a width having length obtained by adding length corresponding to the width of the adhesively fixed portions 14 and 15 being the overlap with to at least the spread length of opening of the groove 9 between the belt-like protrusions 7.

In the present example, an amount of use of the adhesiveness-providing substance can be decreased by a portion of providing the gap 11 in the adhesive layer 4 in comparison with the case of Example shown in FIG. 1.

### Example 3

In the present example, a base material having an adhesive layer was prepared in a manner similar to Example 1 by cutting a commercially available sheet having a dimension of a width of 90 cm and a length of 90 cm under a trade name “COLOR LIFE NON SLIP CLOSET SHEET” (made of polyethylene) (purchased in DAISO INDUSTRIES CO., LTD.) into a sheet having a width of 45 cm and a length of 90 cm to take, as a pet toilet arrangement portion, a space in 20 cm from an end portion, and arranging and attaching a plurality of double coated tapes each having a width of 1.5 cm and a length of 45 cm in parallel to each other by providing a gap of 10 cm in a longitudinal direction of the base material on surfaces other than the above portion in a direction in which the belt-like protrusions 7 are formed. In the present example, regions in 0.25 cm inside from edges on both sides of the double coated tape are respectively adhesively fixed portions (overlap width) 14 and 15 in the adhesive layer on which belt-like protrusions are adhered.

A tape for a belt-like protrusion was prepared on the adhesive layer by cutting a trade name “Airtight Tape for Window” made of polyurethane (purchased in DAISO INDUSTRIES CO., LTD.) having a dimension of a height of 0.8 cm, a width of 1.5 cm and a length of 1 m into a height of 0.8 cm, a width of 1.5 cm and a length of 45 cm. A mat 1 for pet toilet was prepared by peeling release paper on a side of a rear plane of the tape for the belt-like protrusion to expose an adhesive plane of the adhesive layer, and attaching the tapes, across a gap of 1.0 cm in the adhesive layer 4 formed with the double coated tape, onto the adhesively fixed portions (overlap width) 14 and 15 in the adhesive layer 4 formed with the double coated tape on both sides interposing the gap, and forming a plurality of belt-like protrusions 7 in the adhesive layers 4 of the base material 2.

Although the tape having the adhesive layer formed on the rear plane side is used as the raw material for the belt-like protrusion in the present example, a material having no adhesive layer formed on the rear plane side can also be used as the raw material for the belt-like protrusion.

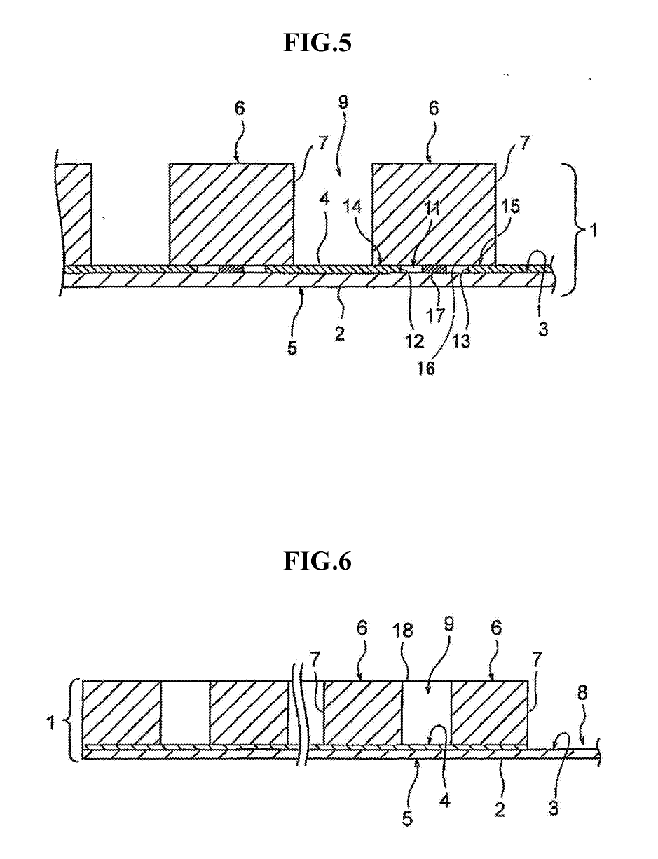

Example shown in FIG. 5 is a case in which a gap 11 formed by cutting away a part in a stripe form along a longitudinal direction was provided, in a manner similar to Example shown in FIG. 4, in a place for adhesively fixing a belt-like protrusion 7 in an adhesive layer 4, but the case that is different, in comparison with Example shown in FIG. 4, in the belt-like protrusion 7 being directly adhesively fixed onto a base material 2 by an adhesive layer 17 for a belt-like protrusion provided on a bottom plane 16 of the belt-like protrusion 7.

That is, in Examples shown in FIG. 5, for example, a belt-like protrusion 7 is formed on the bottom plane 16 of the belt-like protrusion 7 in a place corresponding to an inside of the gap 11 formed in the adhesive layer 4 by applying the adhesive layer 17 for directly adhesively fixing the belt-like protrusion 7 onto the base material 2 or attaching a double coated tape, in the longitudinal direction, pressure bonding the belt-like protrusion 7 onto the base material 2, and directly adhesively fixing the belt-like protrusion 7 onto the base material 2.

In the present example, with regard to the belt-like protrusion 7, the belt-like protrusion 7 is directly adhesively fixed onto the base material 2 through the adhesive layer 17 having adhesive force stronger than the adhesive force of the adhesive layer 4 on the base material. Therefore, the adhesive layer 4 on the base material 2 is to be pressed by the base material 2 and the belt-like protrusion 7 and supported thereon. Accordingly, in the present example, the adhesive layer 4 on the mat 1 for pet toilet is compressed by the belt-like protrusion 7 and fixed onto the base material 2, and simultaneously the belt-like protrusion 7 is to be firmly fixed onto the base material, and the adhesive layer 4 on the mat 1 for pet toilet is to be stably supported onto the base material 2.

In addition, although the adhesive layer 17 for adhering the belt-like protrusion 7 onto the base material 2 is provided on the bottom plane 16 of the belt-like protrusion 7 in the present example, the adhesive layer 17 can be provided on the base material 2 exposed inside the gap 11 of the adhesive layer 4 without providing the adhesive layer 17 on the bottom plane 16 of the belt-like protrusion 7. Also in this case, the adhesive layer 4 of the base material is pressed by the base material 2 and the belt-like protrusion 7, and the belt-like protrusion 7 is to be stably supported in a manner similar to the case in which the adhesive layer 17 is provided on the bottom plane 16 of the belt-like protrusion 7.

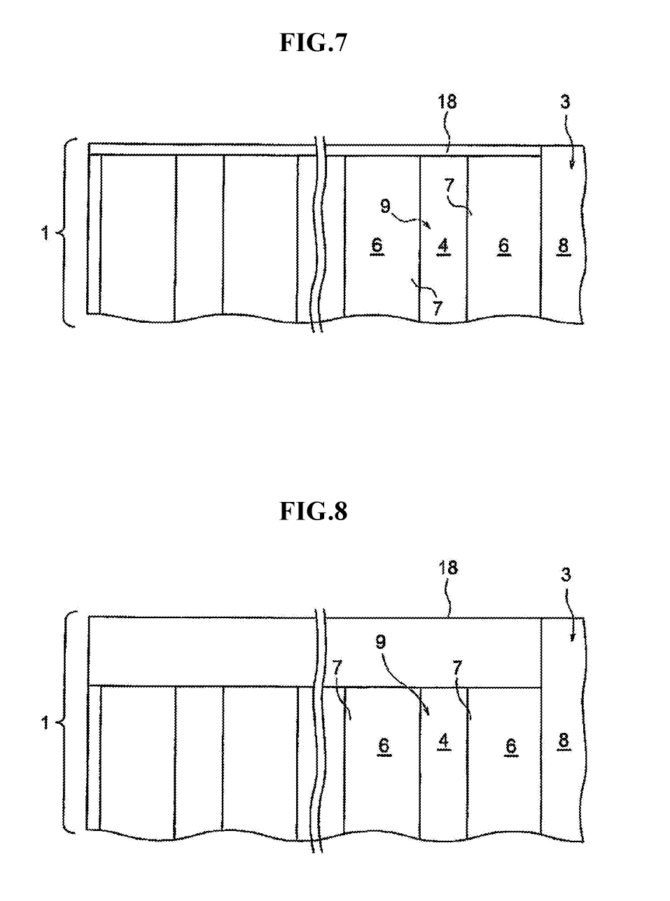

Examples shown in FIG. 6, FIG. 7 and FIG. 8 each are a case that is different, in comparison with FIG. 1, in vertically arranging side walls 18 on both end portions of a groove 9 formed between belt-like protrusions 7 to close the both end portions of the groove 9. FIG. 6 is a side view, and FIG. 7 and FIG. 8 are plan views relative to the side view in FIG. 6.

In Examples shown in FIG. 6, FIG. 7 and FIG. 8, the side walls 18 are vertically arranged by closing opening portions on both ends of the groove 9 formed between the belt-like protrusions 7. In the present example, granular matters (not shown) for pet toilet as attached onto legs of a pet after urination or defecation are dropped from the legs of the pet and separated therefrom in a process in which the pet gets out of the pet toilet and walks on the belt-like protrusion 7, and fall in an adhesive layer 4 of the groove 9 formed between the belt-like protrusions 7 and captured.

In the present example, wall members 18 close the both end portions of the groove 9 between the belt-like protrusions 7. Therefore, the granular matters for pet toilet as dropped from the legs of the pet, fallen in the groove 9, and captured in the adhesive layer 4 inside the groove 9 are accumulated inside the groove 9. The granular matters for pet toilet are accumulated inside the groove 9 in a significant amount while in use. However, the wall members 18 close the both end portions of the groove 9 between the belt-like protrusions 7 in the present example, and thus the opening portions on the both ends are blocked by the side walls 18. Therefore, the side walls 18 prevent the granular matters for pet toilet from leaking from the opening portions on the both ends until the significant amount of the granular matters for pet toilet are accumulated inside the groove 9. Thus, accumulation capacity of the granular matters for pet toilet inside the groove 9 can be increased, and hours of one-time use can be increased.

Example shown in FIG. 7 of the present example is a case in which side walls 18 closing both ends of a groove 9 formed between belt-like protrusions 7 are formed by bending a base material 2, for example, a cardboard, and Example shown in FIG. 8 of the present example is a case in which side walls 18 closing both ends of a groove 9 formed between belt-like protrusions 7 are formed with a raw material having rectangles on both planes of the belt-like protrusion 7.

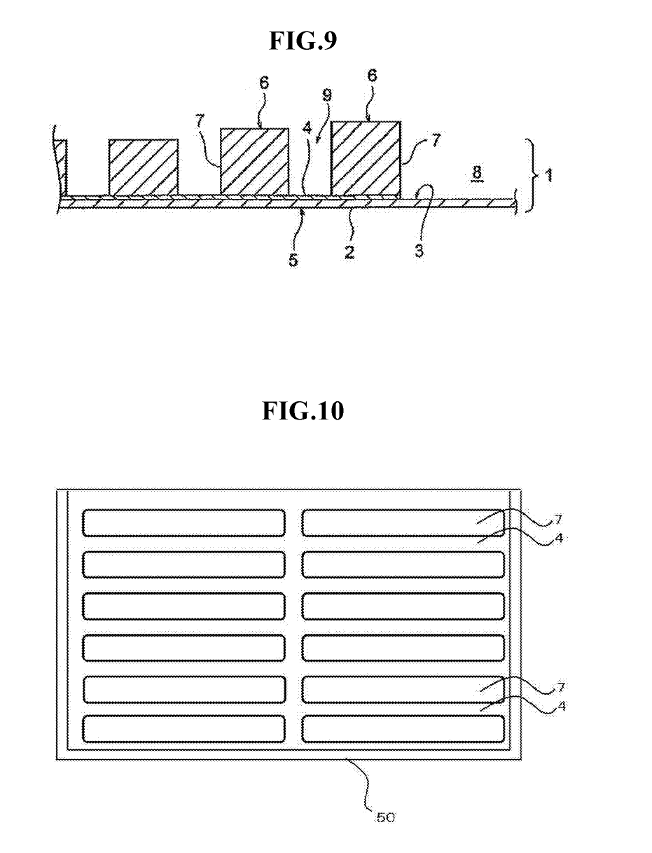

As a modified example of Example of the present invention, as shown in FIG. 9, with regard to a height for a plurality of belt-like protrusions 7, the belt-like protrusion close to an edge portion of a base material is adjusted to be higher than the belt-like protrusion far from the edge portion. Thus, accordingly as the protrusion comes closer to the edge portion of the base material, the granular matters for pet toilet can be made harder to fall out. Moreover, a pet is easily guided to the vicinity of a center portion of the base material.

In addition, for example, the mat may be formed in such a manner that a width of the adhesive layer 4 is decreased or increased accordingly as the layer comes closer to the edge portion of the base material 2.

Moreover, in other Examples of the present invention, as shown in FIG. 10, a wall portion 50 higher than a belt-like protrusion 7 is provided along an edge portion of a base material 2. For example, when the base material 2 is rectangular, the wall portions 50 are provided in three sides. Moreover, the wall portion 50 may be used only in one side. Thus, granular matters for pet toilet can be effectively prevented from falling outside the base material 2.

### INDUSTRIAL APPLICABILITY

A mat for pet toilet of the present invention has simple structure of alternately arranging belt-like protrusions and adhesive portions, and granular matters for pet toilet as attached onto legs or a body of a pet such as a cat are dropped therefrom while the pet walks on the belt-like protrusion, and adhered onto the adhesive portion inside a groove between the belt-like protrusions, captured and held thereon. The granular matters for toilet as captured and held inside the groove are adhered onto the adhesive portion. Therefore, the granular matters are restricted in movement by adhesive force, the granular matters for toilet are not scattered on the floor around the toilet for the pet, an environment in a room can be kept hygienic and satisfactory, and an environment around the pet toilet can be improved. Moreover, in the present invention, opening portions on both ends of a groove 9 are blocked by providing side walls 8, and therefore accumulation capacity of the granular matters for pet toilet in the groove can be increased, and hours of use can be increased.

Accordingly, the mat for pet toilet of the present invention is a product as never before, and significantly contributes to improvement of the environment and is useful in breeding the pet, significantly beneficial to industry, and has significant influence on the industry.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A mat for pet toilet, comprising a base material, a plurality of belt-like protrusions provided on the base material, in which flat planes having no adhesiveness are formed on top portions over entire length thereof, belt-like grooves formed with the belt-like protrusions adjacent to each other, and adhesive layers formed on bottom planes of the grooves.

2. A mat for pet toilet, comprising a base material, adhesive layers provided on the base material, a plurality of belt-like protrusions in which flat planes having no adhesiveness are formed on top portions over entire length thereof, and being adhesively provided onto the adhesive layers, belt-like grooves formed with the adhesive layers and the belt-like protrusions adjacent to each other.

3. A mat for pet toilet, comprising a base material, a plurality of adhesive layers arranged side by side on a surface of the base material by providing gaps between the layers, a plurality of belt-like protrusions in which flat planes having no adhesiveness are formed on top portions over entire length thereof, having bottom plane portions adhered, across the gaps between the adhesive layers on the surface of the base material, onto the adhesive layers on both sides interposing the gaps, and belt-like grooves formed with the adhesive layers and the belt-like protrusions adjacent to each other.

4. A mat for pet toilet, comprising a base material, a plurality of adhesive layers arranged side by side by providing gaps between the layers on a surface of the base material, belt-like protrusions in which flat planes having no adhesiveness are formed on top portions over entire length thereof, and having bottom plane portions adhered, across the gaps between the adhesive layers on the surface of the base material, onto the adhesive layers on both sides interposing the gaps, belt-like protrusions in which bottom plane portions are directly adhered onto the base material through the adhesive layers on the bottom plane portions, and belt-like grooves formed with the adhesive layers and the belt-like protrusions adjacent to each other, wherein the belt-like protrusions are adhered or bonded onto a base material plane through an adhesive agent or a bonding agent in the gaps between the adhesive layers.

5. The mat for pet toilet according to any one of claims 1 to 4, comprising side walls by closing opening portions on both ends of the belt-like grooves formed with the belt-like protrusions adjacent to each other.

6. The mat for pet toilet according to any one of claims 1 to 4, wherein, with regard to a height for the plurality of belt-like protrusions, the belt-like protrusion close to an edge portion of the base material is adjusted to be higher than the belt-like protrusion far from the edge portion.

7. The mat for pet toilet according to any one of claims 1 to 4, wherein a wall portion higher than the belt-like protrusion is provided along the edge portion of the base material.

8. A method of producing a mat for pet toilet, wherein adhesive layers are provided on a base material plane to adhere, onto the adhesive layers on the base material plane, a plurality of belt-like protrusions in which flat planes having no adhesiveness are formed on top portions, and being extended in a belt-like form and formed, and belt-like grooves are formed with the belt-like protrusions adjacent to each other, and adhered, respectively.

9. A method of producing a mat for pet toilet, wherein belt-like protrusions in which flat planes having no adhesiveness are formed on top portions, and adhesive layers are provided on bottom planes and formed in a belt-like form on a base material surface onto which adhesiveness-providing substances are adhered by providing gaps, and a plurality of adhesive layers extending in a belt-like form are arranged side by side by providing the gaps are adhered in the bottom planes, across the gaps between the adhesive layers on the base material surface, onto the adhesive layers on both sides of the gaps, respectively, and simultaneously the belt-like protrusions are directly adhered onto the base material surface through the adhesive layers provided on the bottom planes or the adhesive layers provided inside the gaps between the adhesive layers on the base material, and a plurality of belt-like protrusions are provided on the base material surface by forming belt-like grooves between the layers, respectively.

10. The method of producing the mat for pet toilet according to claim 8 or 9, wherein a plurality of belt-like protrusions are vertically arranged on adhesive layers on a base material surface by forming belt-like grooves between the layers, and release portions on both ends of the grooves are closed by providing side walls in the release portions on both ends of the formed grooves, respectively.
